(19) United States
(12) Patent Application Publication
(10) Pub. No.: US 2012/0054664 A1
(43) Pub. Date: Mar. 1, 2012

(54) METHOD AND SYSTEMS FOR DELIVERING MULTIMEDIA CONTENT OPTIMIZED IN ACCORDANCE WITH PRESENTATION DEVICE CAPABILITIES

(75) Inventors: Scott Dougall, Burbank, CA (US); Ahmad Ouri, Los Angeles, CA (US); Marie-Jean Colaitis, Cesson-Sevigne (FR)

(73) Assignee: THOMSON LICENSING, Boulogne-Billancourt (FR)

(21) Appl. No.: 13/318,901

(22) PCT Filed: Nov. 12, 2009
(86) PCT No.: PCT/US09/06092

§ 371 Date: Nov. 4, 2011

Related U.S. Application Data
(60) Provisional application No. 61/215,627, filed on May 6, 2009.

(51) Int. Cl. G06F 3/048

(52) U.S. Cl. 715/772

(57) ABSTRACT

Methods and systems for optimizing multimedia content or a display of the media content in accordance with an optimal or ideal picture are disclosed. Different content versions that are optimized for different display devices can be remotely generated and transmitted to a receiver connected to the display device. In addition, sets of parameter display settings that are optimized for different display devices can be transmitted to the receiver to permit the display of an optimal picture for multimedia content. Moreover, a description or indication of display device parameters can be transmitted to a remote server for use in the generation of the different versions of content or different sets of parameter display settings.

### RELATED CASES

This application claims the benefit of U.S. Provisional Application No. 61/215,627, filed May 6, 2009 incorporated herein by reference.

### TECHNICAL FIELD

The present invention generally relates to multimedia content delivery, and more particularly, to optimizing multimedia content display.

### BACKGROUND

When connecting a home entertainment system to a content service provider, such as a cable, satellite or internet service provider, for example, users are often required to have some basic understanding of the technical aspects of the system to ensure that they obtain the best picture display possible in accordance with the capabilities of their home entertainment system. Such aspects include the video and audio decoding standards, the scanning parameters supported by a display device, and the bandwidth of the connection to the service provider. However, many users do not have such basic technical knowledge and, as a result, contend with a diminished video display quality, perhaps without even recognizing that they are not availing themselves of the full potential of their home entertainment systems.

### SUMMARY

Exemplary embodiments provide a means to automatically optimize media content or a display of the media content in accordance with an optimal or ideal picture. For example, a remote content server can receive display device parameters from a receiver on a home network of a user and the server can, in turn, transmit multimedia content to the receiver that is optimized for the particular display device of the user. Alternatively, the remote server can transmit a description of parameter settings that are optimized for the display device. Other exemplary embodiments include broadcasting different content versions and/or different sets of parameter settings that can be selected and used by the user's receiver. It should be understood that a “display device,” as employed herein, includes any device that is capable of rendering or presenting any or all types of media and multimedia content, including video and audio elements of such content.

In one embodiment, a method for delivering content from a remote server includes: receiving an indication of client display device parameters over a wide area network from a receiver; determining a version of multimedia content that is optimized for the client display device based on the client display device parameters such that display of said version on the display device parallels the display properties of a predetermined optimal model for the content; and transmitting the version to the receiver.

In an alternate embodiment, a method for delivering content from a remote server includes: receiving an indication of client display device parameters over a wide area network from a receiver; determining parameter display settings for the multimedia content that are optimized for the display device; and transmitting to the receiver the multimedia content and an indication of the determined parameter display settings.

In an another embodiment, a method for receiving multimedia content from a remote server includes: obtaining an indication of display parameters of a client display device; transmitting the indication over a wide area network to a remote server; and receiving a version of multimedia content that is optimized for the display parameters of the client display device.

### BRIEF DESCRIPTION OF THE DRAWINGS

The teachings of the present invention can be readily understood by considering the following detailed description in conjunction with the accompanying drawings, in which:

FIG. 1 is a high level block/flow diagram of an exemplary system for delivering a version of media content that is optimized for a display device in accordance with one exemplary embodiment of the present invention.

FIG. 2 is a high level block/flow diagram of an exemplary system for delivering media content and a set of display device parameter settings that is optimized for a display device in accordance with one exemplary embodiment of the present invention.

FIG. 3 is a high level block/flow diagram of an exemplary system for broadcasting different versions of media content that are optimized for different corresponding display devices in accordance with one exemplary embodiment of the present invention.

FIG. 4 is a high level block/flow diagram of an exemplary system for broadcasting media content and different sets of display device parameter settings that are optimized for different corresponding display devices in accordance with one exemplary embodiment of the present invention.

FIG. 5 is a high level block/flow diagram of an exemplary method for delivering a version of media content that is optimized for a display device in accordance with one exemplary embodiment of the present invention.

FIG. 6 is a high level block/flow diagram of an exemplary method for receiving a version of media content that is optimized for a display device in accordance with one exemplary embodiment of the present invention.

FIG. 7 is a high level block/flow diagram of an exemplary method for delivering media content and a set of display device parameter settings that is optimized for a display device in accordance with one exemplary embodiment of the present invention.

FIG. 8 is a high level block/flow diagram of an exemplary method for receiving media content and a set of display device parameter settings that is optimized for a display device in accordance with one exemplary embodiment of the present invention.

FIG. 9 is a high level block/flow diagram of an exemplary method for broadcasting different versions of media content that are optimized for different corresponding display devices in accordance with one exemplary embodiment of the present invention.

FIG. 10 is a high level block/flow diagram of an exemplary method for receiving and selecting between broadcasted versions of media content that are optimized for different corresponding display devices in accordance with one exemplary embodiment of the present invention.

FIG. 11 is a high level block/flow diagram of an exemplary method for broadcasting media content and different sets of display device parameter settings that are optimized for different corresponding display devices in accordance with one exemplary embodiment of the present invention.

FIG. 12 is a high level block/flow diagram of an exemplary method for receiving media content and selecting between broadcasted sets of display device parameter settings that are optimized for different corresponding display devices in accordance with one exemplary embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION

In accordance with exemplary embodiments of the present invention, a “perfect picture” for a customer's home entertainment system can be automatically provided by a service provider, thereby eliminating the need for a customer to understand the capabilities of their home system and to permit the customer to be confident that they are enjoying the best viewing experience possible. For example, as opposed to providing users with options concerning video and audio compression standards, scanning parameters, etc., the service provider can automatically optimize the picture with little or no user interaction.

Furthermore, even if a user does have a basic technical understanding of their home entertainment system, oftentimes content providers deliver content that does not exploit the full capabilities of a user's home entertainment system or display device. For example, content providers that deliver content over networks, such as cable or satellite networks or the interne, conform the content to the recommendation (Rec) 709, or ITU-R BT.709 (International Telecommunications Union Radio Communication Sector Broadcast Television recommendation 709), standard, which specifies the basic colorimetry used in today's HD (high definition) television systems. Similarly, the Rec 601 standard specifies the basic colorimetry used in today's SD (standard definition) television systems. Content in Rec 709 or Rec 601 systems is traditionally proof-viewed on cathode ray tube (CRT) systems, which de facto imposes additional colorimetric requirements, such as European Broadcasting Union (EBU) requirements. However, even if the content closely parallels Rec 709 or Rec 601 standards, newer technology displays such as plasma, liquid crystal displays (LCDs), LCD with light emitting diodes as backlight (LED+LCD), organic light-emitting diode (OLED), digital light processing (DLP) projectors have characteristics that are different from CRT and reproduce different colors for identical content. In particular, these different devices typically have a color gamut that is broader than the Rec 709 or Rec 601 gamut and have the potential to provide a richer viewing experience over content conformed to Rec 709 or Rec 601. Thus, content delivered to display devices may not be optimized for the specific home entertainment system of the user, and, as a result, the full potential of the user's entertainment system is not fully utilized.

Various exemplary embodiments of the present invention can be implemented to tailor content or its display to fully utilize the capabilities of a user's home entertainment system. For example, as noted above, various parameters can be considered to provide a “perfect picture” on a user's display. Such parameters can include sound and video decoding standards, processing power, network bandwidth, multi channels sound support (mono, stereo, surround, etc), audio and video codec parameters, network latency, local storage and buffering capacity, two-dimensional (2D) vs. three-dimensional (3D) capabilities, 3D stereo signal format, etc. In addition, such parameters can include display parameters such as color parameters, gamma (rendition of dark area), aspect ratio, screen size, screen resolution. As described herein below, various methods and systems can be implemented to optimize content in accordance with a user's home entertainment system, or, alternatively or additionally, to optimize a user's display device to in accordance with “ideal” settings for specific content. Further, users can be given the option of upgrading their picture or display settings after an initial setup if they later obtain a higher quality home network or system using the principles disclosed herein.

To facilitate understanding of aspects of the present invention, reference is now made to the drawings in which like reference numerals identify similar or identical elements throughout the several views. The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

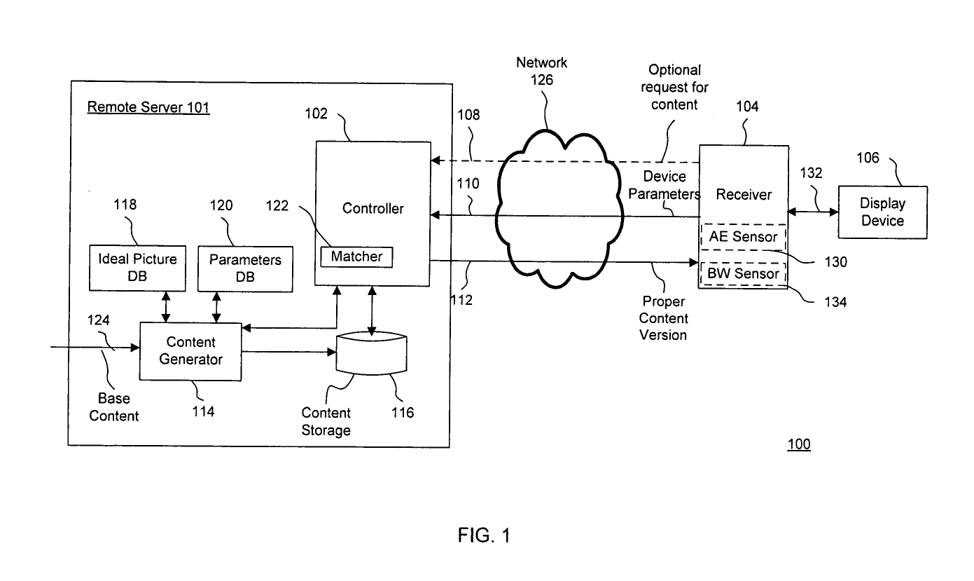

Referring now to FIG. 1, a content delivery system 100 in accordance with one exemplary embodiment of the present invention is illustrated. Although only one receiver is shown here and in other drawings for ease of understanding, it should be understood that the systems described herein can comprise many receivers that receive content from a remote server. In system 100, a receiver 104 connected to a user's home local area network and/or entertainment system display device 106 can automatically identify the local parameters of the display device and can send an indication of the local parameters to a remote content provider server 101 along a channel 110 over a wide area network 126. It should be understood that the term “wide area network,” in addition to its ordinary technical meaning in the art, is defined herein as further including a cable broadcast network, optical broadcast network, satellite broadcast network, and unicast and multicast networks implemented on the Internet. Additionally, a “wide area network” further includes a metropolitan area network and a campus area network.

Channel 110 can also be implemented as a cable back channel in certain networks, such as a satellite network. The indication can, for example, be a product company and model number. Further, the connection 132 between the receiver and the display device 106 can be an HDMI (high definition multimedia interface) connection. The receiver can determine the display device manufacturer identification number and the model identification number by implementing the Video Electronics Standards Association (VESA) Enhanced Extended Display Identification Data Standard (E-EDID), which is supported by HDMI. Alternatively, the receiver can request the user to type in such information, for example, during installation. In various exemplary embodiments, the indication need only be sent to the remote server once and can be stored locally in memory allocated to a controller 102. In addition, system 100 can optionally be implemented in an on-demand setting in which a request for specific video content can be transmitted along a channel 109 through network 126 or through a back channel.

Remote server 101 can include an ideal picture database 118 and a parameters database 120. The ideal picture database can specify any “ideal” parameters for various content that permit the content to be displayed in accordance with pre-determined specifications. For example, the ideal parameters can describe a predetermined optimal parameters model and can specify parameter settings corresponding to the original intent of a director such that the content can be displayed in a manner that is equivalent to a theatrical setting. Such parameters can include display settings such as color settings, brightness, contrast and other display parameters. Parameters database 120 can, in turn, include a description of various parameters corresponding to different types of display devices or home entertainment systems. For example, as mentioned above, such parameters can include video and sound decoding standard compatibility, color gamut, aspect ratio, screen size, processing power, video codec parameters, screen resolution, local storage capacity, two-dimensional vs. three-dimensional capabilities, etc. In addition, the parameters database can cross-reference sets of such parameters to make and model numbers of various display devices or entertainment systems. Such cross-references can be employed to minimize the bandwidth resources used by the receiver to transmit the parameter indications.

The remote server 101 can further include a content generator 114 that can be configured to receive base video content 124, which can, for example, be in compliance with the Digital Cinema Initiatives (DCI) standard, and generate a plurality of versions of the content for storage in content storage device 116. For example, the content generator 114 can be configured to tailor each content version to each display device or entertainment system listed in the parameters database 120 using the ideal picture database 118. For example, certain display devices can have broader capabilities than others and, in turn, the content generator 114 can create the content in such a way that it fully exploits the capabilities of the corresponding display devices so that the content version matches, as much as possible, the parameters listed in the ideal picture database 118. Each version can be stored with a reference to a make and model number to facilitate retrieval.

The controller 102 can reference the device parameters received along channel 110 and can employ a matcher 122 to find the content version corresponding to the display device 106. As noted above, the device parameters received from receiver 104 can include a make and model number that can be matched to a corresponding content version stored in storage device 116. Thus, the controller 102 can select the appropriate content from a content database 116. Alternatively, the device parameters received from receiver 104 can optionally send a listing of the device parameters. The listing can be sent if the parameters database 120 does not include the particular display device 106. In this case, the content generator can generate the content on-the-fly to tailor the content to the display device 106, as discussed above. In certain embodiments the listing can be sent initially, with or without a make and model number. Alternatively, the listing can be sent in response to a query from the server 101 if the server determines that it does not include the make and model initially sent by the receiver. After the proper content version is found or generated, it can be sent to receiver 104 and transmitted to the display device 106 for display. It should also be noted that, alternatively, if a version for display device 106 has not been generated, then a default version can be sent to receiver 104 along channel 112.

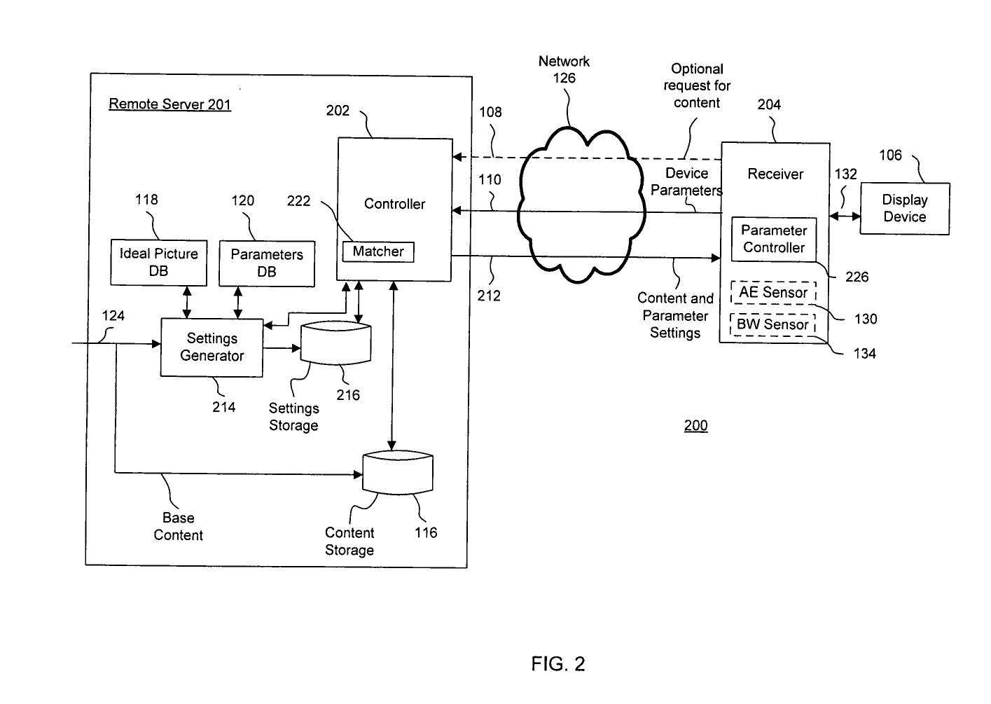

With reference now to FIG. 2 with continuing reference to FIG. 1, a content delivery system 200 in accordance with another exemplary embodiment of the present invention is illustrated. As in system 100, the receiver 204 can transmit the same device parameter indications along channel 110, as discussed above, and, optionally, as mentioned above, can transmit a request for certain video content along channel 108 to the remote sever 201 over network 126. As in system 100, the remote server 201 can include the ideal picture database 118 and the parameters database 120. However, as opposed to transmitting a tailored version of content, the server can transmit to the receiver 204 both the base content and a set of parameter settings along channel 212 in network 126. For example, remote server 201 can include a settings generator 214 that employs the parameters stored in the ideal picture database 118 and the parameters stored in parameters database 120 to generate different sets of parameter settings. For example, each display device or entertainment system provided in the parameter database 120 can have a corresponding, different set of parameter settings. Here, the settings generator 214 can create each set of parameter settings in such a way that it fully exploits the different capabilities of the corresponding display devices when the content is displayed on the corresponding display device. For example, if the corresponding display device for a particular set of parameter settings displays the content in accordance with the set of settings, then the user can be provided with a display that matches the ideal picture parameters provided in database 118 as much as possible. For example, the set of parameters can specify include color settings, brightness, volume, and other similar parameters. Further, each set of parameter settings can include metadata indicating how the parameter controller 226, discussed further below, in receiver 204 should adapt the media content transmitted by the server to the display device 106. For example, as discussed further below, such adaptation can include performing color transformations to tailor the content to the display device capabilities.

Using the device parameter indication received from receiver 204 along channel 108, the controller 202 can employ a matcher 222 to match the indication provided with one of the sets of settings generated by the settings generator 214. For example, the sets of parameter settings can be stored in a settings storage device 216 with reference to a make and model number of corresponding display devices. The matched settings can be transmitted to the receiver 204 along channel 212 in network 126.

In response to receiving the parameter settings, the receiver can employ a parameter controller 226 to set the display device in accordance with the set of parameter settings received from server 201. For example, the parameter controller 226 can set the color settings, brightness, volume, etc. In addition, as discussed additionally below, the parameter controller 226 can also be configured to perform color transformations. The receiver 204 can transmit the video content received from server 201 to the display device 106 for display in accordance with the set of parameter settings.

It should be noted that similar to system 100, the parameter settings generator 214 can generate sets of parameter settings on-the-fly. For example, as noted above, on-the-fly generation can be performed if the particular display device 106 is not listed in the parameters database 120. Thus, the server 201 can generate a set of parameters tailored to display device 106 and can transmit the set of parameters in response to receiving a list of parameters transmitted through channel 108 initially or in response to a server query, as discussed above. Further, as stated above, if a set of parameter settings for display device 106 has not been generated, then a default set of settings can be sent to receiver 204 along channel 212.

It should also be understood that optional variations of systems 100 and 200 can include an ambient environment sensor 130 that can be configured to measure ambient lighting conditions around the display device 106. For example, the ambient environment sensor 130 can measure the color and/or intensity of light surrounding the display device and transmit the color/intensity information with the device parameter indications along channel 108. Thus, in this scenario, the server 101 in system 100 can generate a version on-the-fly with consideration of the ambient light conditions so that the displayed content can match the ideal picture parameters in database 118 as much as possible. This version can be transmitted along channel 112 over network 126. In turn, in system 200, the settings generator 214 can generate the set of settings on-the-fly with consideration of the ambient lighting conditions around display device 106. The set of settings can include an indication of the degree in which the lighting should be modified. For example, the parameter controller 226 can be configured to display a message to the user indicating that the lighting should be dimmed or intensified and can use the sensor 130 to indicate to the user when the lighting has been adjusted to a degree sufficient to meet the setting provided in the set of parameter settings received from server 201. Alternatively, the adjustment can be made automatically by the parameter controller if a sufficient interface is provided between the receiver and the light source on the user's premises.

Furthermore, for ambient lighting, alternatively the adaptation process could be done directly within the receiver. For example, the sensor can measure lighting conditions and the measurement can be used by the receiver to select a subset of the color configuration settings received from server along channel 212 and use it for color processing. Thus, a set of color parameter settings can include several subsets of parameters, one for each lighting level, such as dim, dark, normal, bright, etc.

Moreover, optional variations of systems 100 and 200 can include a bandwidth sensor 134 that can be configured to measure the bandwidth of the receiver's network connection. The bandwidth can be one device parameter that is transmitted to the remote server, which in turn, can use the bandwidth to tailor a version of video content to the specific bandwidth constraints of the network 126 or a local network on which the display device 106 is connected. Bandwidth measurement and use is further described below with respect to a color optimization example.

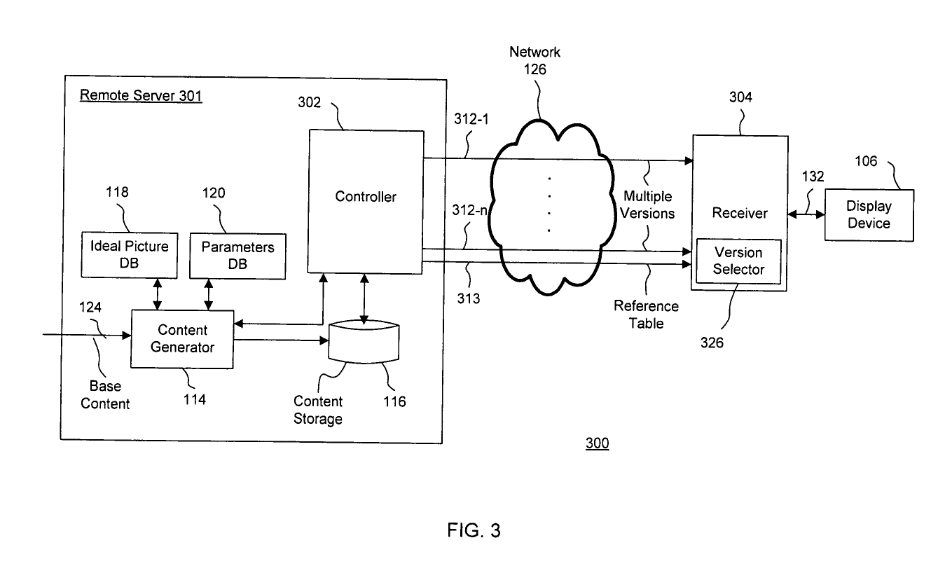

With reference now to FIG. 3, with continuing reference to FIG. 1, a content delivery system 300 in accordance with another exemplary embodiment of the present invention is illustrated. Here, remote server 301 can include the content generator 114, the ideal picture database 118, the parameters database 120, and the content storage device 116, all of which can perform the same functions described above with respect to system 100. However, system 300 differs from system 100 in that the selection decisions are performed at the receiver 304. For example, the controller 302 in remote server 301 can be configured to retrieve and broadcast all of the content versions, for example n versions, stored in content storage device 116 to a plurality of receivers. The n versions can be transmitted to receiver 304 along one or more of channels 312-1 to 312-n. In addition, the remote server 301 can transmit the multiple versions with indications of corresponding sets of video display device parameters. For example, the server 301 can transmit a reference table 313 mapping channel or packet identifiers for each content version with a corresponding device make and model. Thus, receiver 304 can include a version selector 326 that can receive and use the indications to match the corresponding display device 106 with the proper version. For example, the version selector 326 can use the reference table 313 to match the make and model of the display device 106 with the proper version. In response to the version selector 326 selection of the proper version, the receiver 304 can transmit the proper, optimized content version to display device 106 for display.

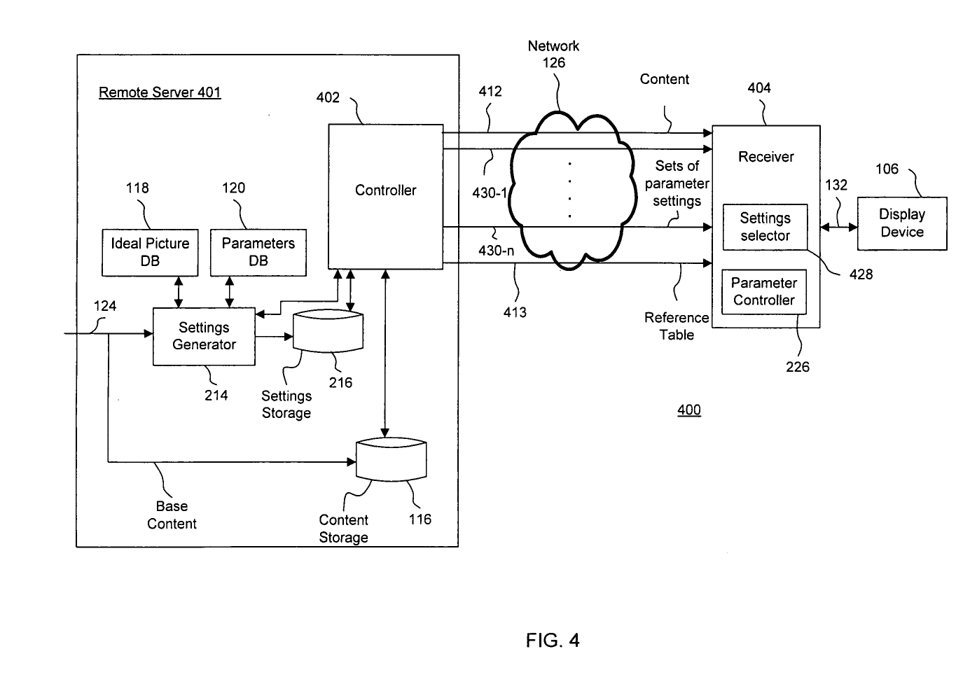

With reference now to FIG. 4, with continuing reference to FIG. 2, a content delivery system 400 in accordance with another exemplary embodiment of the present invention is illustrated. In system 400, remote server 401 can include the settings generator 214, the ideal picture database 118, the parameters database 120, the settings storage device 216 and the content storage device 116, all of which can perform the same functions described above with respect to system 200. System 400 differs from system 200 in that the selection decisions are performed at the receiver 404. For example, the controller 402 in remote server 401 can be configured to retrieve and broadcast content from the content storage device 116 along channel 412 to a plurality of receivers. In addition, the controller 402 can also retrieve and broadcast all of the sets of parameter settings, for example n sets of parameters, stored in settings storage device 216 to the plurality of receivers. For example, n sets of parameters can be transmitted to receiver 404 along one or more of channels 412-1 to 412-n. In addition, the remote server 401 can transmit the multiple sets of parameters with indications of corresponding sets of video display device parameters. For example, the server 401 can transmit a reference table 413 mapping channel or packet identifiers for each set of parameters with a corresponding device make and model. Thus, receiver 404 can include a settings selector 426 that can receive and use the indications to match the corresponding display device 106 with the proper set of settings. For example, the selector 426 can use the reference table 413 to match the make and model of the display device 106 with the proper set of parameter settings. In response to selection of the proper set of parameter settings by the settings selector 428, the parameter controller 226 can modify the display device settings in accordance with the proper set of settings, as discussed above with respect to method 200. The receiver 304 can transmit the content to display device 106 for display in accordance with the optimized parameter settings.

It should also be understood that the system embodiments discussed above focus on specific features to simplify and ease understanding of the features. However, any of the aspects discussed above with regard to one system embodiment can be combined with or added to any one or more of the other system embodiments described. For example, a system can be derived that employs both transmitting one or more content versions and transmitting one or more sets of parameter settings. Thus, although certain aspects are described with respect to one embodiment, those aspects can be implemented in any of the other embodiments described.

Further, in each of the embodiments discussed herein, the receiver can be configured to automatically identify the local parameters of the display device, including network connection characteristics as well as device capabilities. Alternatively or additionally, as noted above, the receivers can simply obtain the make and model number of the display device 106, and the set of parameters for a particular device can be cross referenced to the make and model of the display device at the remote server. As noted above, the set of parameters can include a description of video and audio decoding standards supported by the display device or the home network. Such decoding standards can include WMV (windows media video), VC1 (Video Coding 1), MPEG (moving pictures experts group), MPEG2, H.264/MPEG-4 AVC (advanced video coding), SVC (scalable video coding), MVC (Multi View Coding), AAC (advanced audio coding), AC3 (Dolby Digital, Audio Codec 3), MP3 (MPEG-1 Audio Layer 3), etc. As noted above, the remote server can transmit to the receiver video content that is encoded with the particular coding standards that is supported by the display device. Alternatively, the content can be converted to the appropriate coding standard at the receiver using, for example, the set of parameters settings transmitted by the server, although this option can be less efficient with additional costs. It should also be noted that display device or home system parameters can include the container format that is supported, such as, for example, MPEG-2 TS (transport stream), MPEG4 file format, Matroska, Flash, QuickTime, IP encapsulation, etc. Of course, the remote server can transmit the video content to the receiver in accordance with the container format that is supported by the display device, home network or home entertainment system.

Other parameters can include the scanning parameters supported by the display device or the home entertainment system. Such scanning parameters can include HD or SD, 480i, 480p, 720p, 1080i, 1080p, and can include scanning rate, such as 60 Hz or 50 Hz, etc. The scanning parameters can be used by the remote server to optimize the content to be delivered with consideration of its bit-rate. These scanning parameters could be either retrieved using the brand/model information or extended display identification data (EDID)/consumer electronics control (CEC) HDMI data.

Furthermore, the parameters can include the bandwidth of a wide area network (WAN) and/or local area network (LAN) employed by the display device or entertainment system. The bandwidth parameters can, for example, be measured in real-time by the receiver by monitoring the bit stream input buffer filling. Alternatively, the user can declare the WAN bandwidth he or she has subscribed from network operators. Such information can be prompted by the receiver on the display device and input by the user. The bandwidth information can be used by the server 201 to generate a content version for a particular display device that is optimized for the bandwidth supported. For example, a version with higher bit rate can be generated for a higher bandwidth while a version with a lower bit rate can be generated for lower bandwidths. For example, a tiered set of bandwidths can be cross-referenced to a tiered set of bit rates such that any bandwidths received from a receiver that falls within a tiered interval can be assigned a corresponding bit rate. As noted above, the version can be pre-generated or generated on the fly. The scanning resolution parameters (HD, SD, 480i, 480p, 720p, 1080i, 1080p, etc) that can be used by the server to prepare/select the content could also be derived from the estimation of the receiver available bandwidth. For example, a decrease or increase of the bandwidth can lead to selection of a lower or higher resolution, respectively. Reducing the resolution is a convenient means to reduce the bit-rate.

Certain parameters can correspond to “3D” (three-dimensional) viewing applications. For example, the parameters can include a video 3D encoding scheme, such as multi-view video coding (MVC), advanced video coding (AVC) with half resolution per view, dual AVC in parallel, etc. Other such parameters can include the display 3D rendering capabilities, such as full 3D, 3D ready, and also the format supported, such as line sequential, frame sequential, quincunx, etc. Yet other parameters can specify whether the display device or home entertainment system can carry two video views such as HDMI 1.3 or 1.4, etc. As discussed above, the remote server can generate a version of the content that is globally compatible with the decoding scheme, 3D rendering capabilities and the format supported by the display device and can also deliver to the receiver any necessary parameter settings that can be used to configure the complete user installation. In addition, for certain exemplary parameters, the receiver can modify and convert the content to standards appropriate to the display device. For example, depending on the hardware capabilities of the receiver, SD can be converted to HD and vice-versa.

As mentioned above, the parameters can also include color information. For example, the color information can be the parameters defined in the “gamut identification” or “gamut ID” standard currently under discussion at the International Electrotechnical Commission (IEC). The gamut ID for a particular device can be transmitted by the receiver or the gamut ID can be stored in the parameters database and referenced using a model and make, as discussed above.

To aid in understand of aspects of the present invention, reference is now made to a description of how color information can be used to optimize a display by generating a specific optimized content version and/or by generating sets of parameter settings. Color information is just one example of a parameter type; however principles discussed herein can be extended to other parameters discussed above. The color information can be used to ensure that the rendition of colors on a display device matches or closely parallels “original” movie colors. For example, the “original” movie colors can correspond to the color specified by a director as he or she intended the movie or film to be viewed in a theatrical setting.

To optimize content and/or display settings in this way, several different components should be considered. One such component is the original video content itself, such as base content 124, discussed above. In accordance with exemplary aspects of the present invention, the original video content can be received in a DCI format, as with this format, a full color spectrum locus could be represented. Other considerations include the head-end or the remote server. Prior to delivering the video content to the network, the DCI content can be color processed to match a delivery format, such as Rec 709 and 4:2:2. In the head-end there are some processing capacities to handle this transformation which could be adapted to the ideal picture specification or a predetermined optimal parameters model, such as those discussed above with respect to the ideal picture database 118. Another consideration is the receiver, which can be implemented in a consumer set-top-box (STB). This STB can have some capacity to handle color transformations, as specified, for example, in a set of parameter settings received from the remote server, using appropriate hardware and/or software.

The display device, where colors are finally rendered for viewing, is another consideration. Rendition is made in accordance with the display's capabilities, such as color primaries, gamma, contrast, luminosity, etc. As noted above, most display devices are designed to conform with the Rec 709 or Rec 601 gamut. This is typically the case with CRT but LCD, Plasma, DLP and emerging technologies are beginning to widen the limits of the 709 and 601 gamuts. The color management performed by exemplary embodiments of the present invention can be include correction of some mismatch between the theoretical Rec 709 gamut and the given display actual gamut one. Further, the color management can improve detail rendering in dark area by employing the gamma. The consumer's viewing conditions can also be considered. As noted above, an ambient environment sensor can be employed to account for ambient light. Typically, ambient light is under the customer control. As such, viewing condition guidelines can be provided to the user to permit optimal color rendition. For example, as noted above, with use of a sensor, the parameter controller in the receiver can display messages instructing how the ambient light should be adjusted. Alternatively, if a sensor is not employed, a general description can be provided to the user in the form of a display message.

Reference is now made to system 200 of FIG. 2, which is used as an example to describe how color optimization can be implemented in an exemplary embodiment. However, the principles discussed herein below can be employed in any system discussed above or in any combination of systems. When the consumer connects a new display device 106 to receiver 204, implemented as a set top box, using an HDMI cable, for example, the display device brand and model can be acquired by the set top box using, for example, EDID protocol on the HDMI cable, or can be acquired manually. The consumer can also be instructed to reset the display to default color, contrast and other settings as recommended by a STB user-guide, or the STB can reset the display to these settings using the adequate protocol, such as CEC or HDMI 1.4. The STB connects to the remote server 201 and sends a request with the display device brand/model. Further, the corresponding color correction metadata, such as 3×1D lookup tables (LUTs) and matrix coefficients, can be transmitted from the remote server and retrieved and stored locally on the STB for use during the performance of color transformations. The hardware in the set top box for color correction can be a 3×3 matrix and 3×1D-LUT.

When optimized content in accordance with Rec 709 or Rec 601 is watched, the set top box can be configured to apply the color and gamma correction in real-time. The consumer can also be instructed to darken or light her viewing room according to the user-guide. The benefit for the consumer will be to have a more consistent color rendition of the content. In addition, it should be noted that although the Rec 709 or Rec 601 standard is used, a wider color gamut can be employed. For example, a wider color gamut would be appropriate in accordance with the capabilities of the display device, such as plasma, OLED, LED, DLP and LCD devices, for example.

The set top box can be used to decode the content during play back or streaming and can be capable of real time color processing functionalities. Such functionalities could be application of 3×1D Look Up Tables (LUTs), correction of Electro-optical transfer function (EOTF), contrast, white level, black level, etc. Other such functionalities can include application of 3×3 linear (programmable) matrix: primaries color correction, white point color temperature, and hue. Further, as noted above, the set top box can be capable of capturing display screen color capabilities. This can be done either manually by prompting the user to type in the brand and model of the display device, or it can be done automatically using the EDID/HDMI protocol, for example. The set top box can then connect to the remote server and retrieve all color correction information such as ID LUT content, matrix coefficients, etc. For wider color gamut display devices, a 3D LUT can be prepared by the server and used by the STB for color transformations. The STB can also indicate to the server which kind of color transformation hardware it embeds, such as 3×3 matrix plus 3×1D LUT vs a (pseudo) 3D LUT, in addition to the display brand and model. Based on the color transformation hardware information, the server can compute the settings to be used by the STB color correction hardware. The display settings are generally different for different types of color transformation hardware, such as a 3×3 matrix plus 3×1D LUT or a (pseudo) 3D LUT.

Further, the remote server can host a display screen database holding target display devices characteristics and corrections to be downloaded in the set top box. The database can also include receiver hardware information, such as color transformation hardware. The display screen database and receiver can be included in the settings storage device 216. There are several ways to construct the display screen database, such as measuring characteristics of all existing display devices or obtaining detailed specifications from the display device manufacturers.

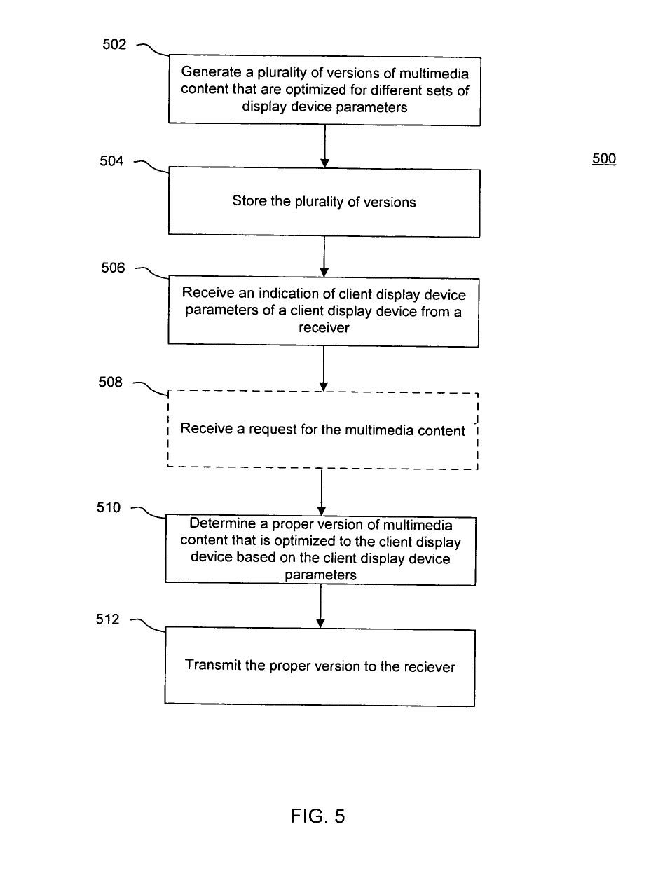

With reference now to FIG. 5 with continuing reference to FIG. 1, a method 500 for delivering content in accordance with one exemplary embodiment of the present invention is illustrated. For example, method 500 can be performed by remote server 101 of system 100. Method 500 can begin, for example, at step 502 in which the content generator 114 can generate a plurality of versions of multimedia content that are optimized for different sets of display device parameters, as discussed above. Further, the versions of multimedia content can be generated so that they parallel the parameters in the ideal picture database 118 for the content as much as possible, as discussed above. Alternatively, the plurality of versions need not be generated at the server but can be received from a remote content generator and stored directly in the content storage device 116.

At step 504, the server 101 can store the plurality versions in the content storage device 116.

At step 506, the remote server 101 can receive an indication of client display device parameters of a client display device 106 from a receiver, as discussed above. The indication can be transmitted over network 126 or over a back channel. Further, the indication can be a make and model number or it can be a detailed description of client device parameters, as discussed above.

Optionally, at step 508, the server 101 can receive a request for multimedia content. For example, as noted above, system 100 can be used in an on-demand setting.

At step 510, the controller 102 can determine a proper version of multimedia content that is optimized for the client display device based on the client display device parameters. For example, as discussed above, the controller 102 can employ a matcher 122 to match the indication of client display device parameters with a corresponding version that is optimized for the client display device parameters. For example, as discussed above, the matcher can match display and model number with corresponding version that references that display and model number. Alternatively, as discussed above, the server 101 can determine a proper version of multimedia content that is optimized for the client display device by generating the proper version on-the-fly. For example, in response to receiving the indication of client display device parameters and/or a request for the multimedia content, the content generator 114 can generate a version tailored to the parameters of display device 106.

At step 512, the server 101 can transmit the proper version to the receiver.

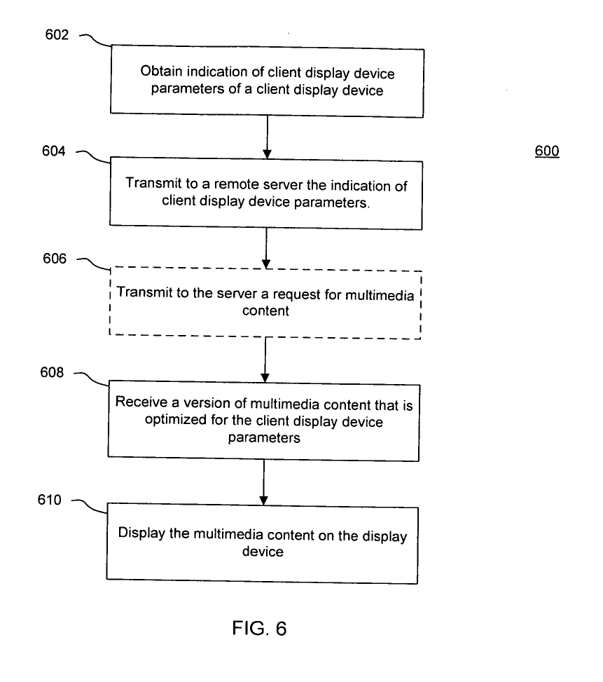

With reference to FIG. 6, with continuing reference to FIGS. 1 and 5, a method 600 for receiving multimedia content from a remote server in accordance with an exemplary embodiment of the present invention is illustrated. Method 600 can be performed by receiver 104 and can complement method 500. Method 600 can begin at step 602, in which the receiver 104 can obtain an indication of the parameters of the client display device 106, as discussed above. For example, the indication can be a display device make and model, as discussed above. Further, parameters, such as scanning parameters can be obtained using an HDMI connection, as discussed above. In addition, receiver 104 can employ sensors 130 and 134 to obtain client display device parameters. For example, as discussed above, the ambient environment sensor 130 can be configured to measure ambient light color and intensity. Further, the bandwidth sensor 134 can be configured to measure the bandwidth of a transmission channel 110, 108 connected to the remote server.

At step 604, the receiver 104 can transmit the indication of client display device parameters of the client display device 106 to the remote server, as discussed above. For example, as discussed above, the indication can include the make and model of the display device and can include explicit description of the parameters. As noted above, such parameters can include decoding and scanning parameters, ambient environment information and bandwidth.

Optionally, at step 606, the receiver 104 can transmit a request for multimedia content, as discussed above.

At step 608, the receiver 104 can receive a multimedia content version that is optimized for the client display device parameters, as discussed above, and at step 610, the multimedia content version can be displayed on the display device 106, as discussed above.

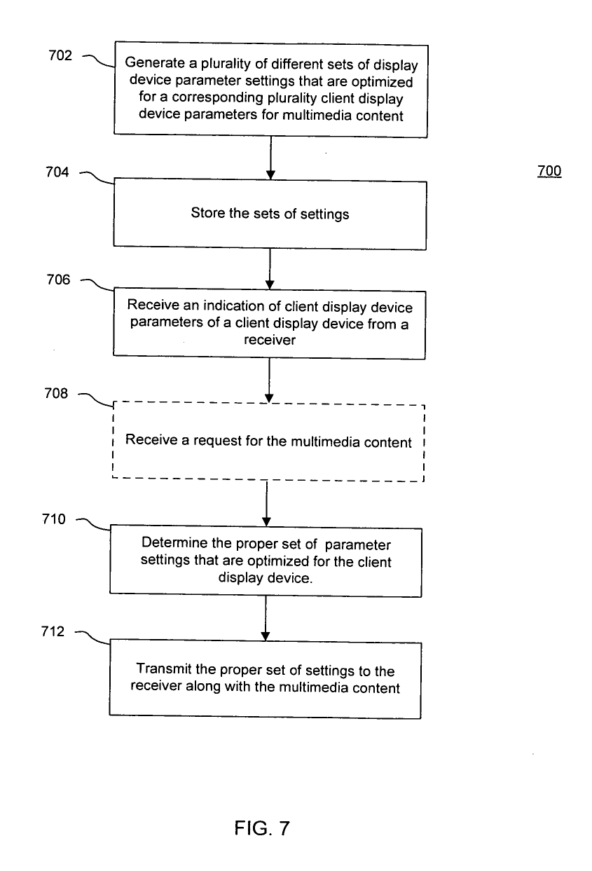

With reference now to FIG. 7 with continuing reference to FIG. 2, a method 700 for delivering content in accordance with one exemplary embodiment of the present invention is illustrated. For example, method 700 can performed by remote server 201 of system 200. Method 700 can begin, for example, at step 702 in which the settings generator 214 can generate a plurality of different sets of display device parameter settings that are optimized for a corresponding plurality client display device parameters for the multimedia content, as discussed above. Further, the sets of parameter settings can be generated so that they parallel the parameters in the ideal picture database 118 for the content as much as possible, as discussed above. As noted above, a set of settings can parallel, for example, the color specifications set by a director of the multimedia content for its display in a theatrical setting. The set of color specifications can parallel a predetermined optimal parameters model provided in the ideal picture database 118. Alternatively, the plurality of versions need not be generated at the server but can be received from a remote settings generator and stored directly in the settings storage device 216.

At step 704, the server 201 can store the generated sets of parameters settings in the settings storage device 214.

At step 706, the remote server 101 can receive an indication of client display device parameters of a client display device 106 from a receiver 204, as discussed above. The indication can be transmitted over network 126 or over a back channel. Further, the indication can be a make and model number or it can be a detailed description of client device parameters, as discussed above.

Optionally, at step 708, the server 201 can receive a request for multimedia content. For example, as noted above, system 200 can be used in an on-demand setting.

At step 710, the controller 202 can determine a proper set of parameter settings that is optimized for the client display device based on the client display device parameters. For example, as discussed above, the controller 202 can employ a matcher 222 to match the indication of client display device parameters with a corresponding set of parameter settings that is optimized for the client display device parameters. For example, as discussed above, the matcher can match a display and model number with a corresponding set of parameter settings that references that display and model number. Alternatively, as discussed above, the server 101 can determine a proper set of settings that is optimized for the client display device by generating the proper version on-the-fly, in real time. For example, in response to receiving the indication of client display device parameters and/or a request for the multimedia content, the settings generator 214 can generate a set of settings tailored to the parameters of display device 106.

At step 712, the server 201 can transmit the proper set of settings to the receiver along with the multimedia content.

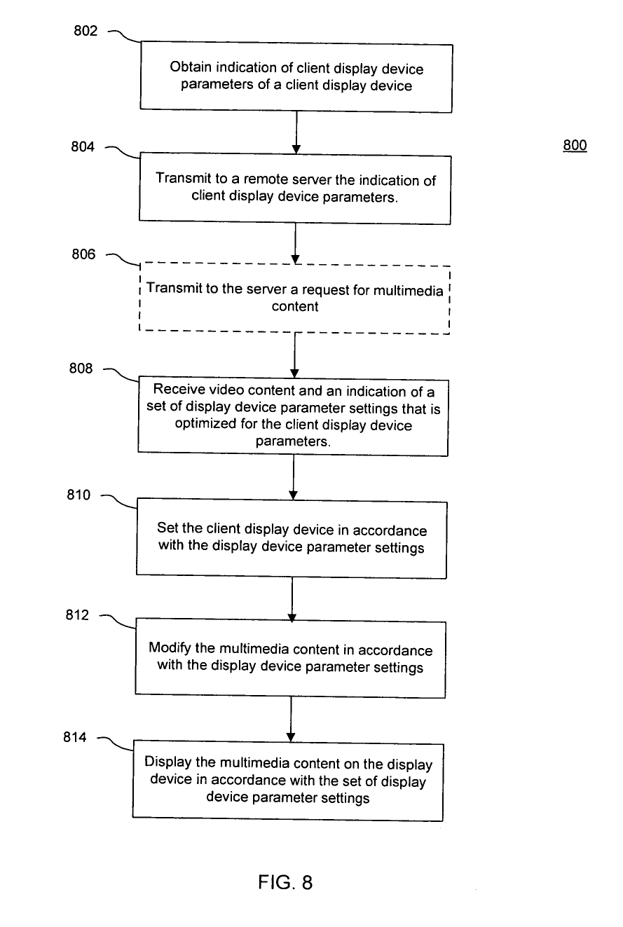

Referring to FIG. 8, with continuing reference to FIGS. 2 and 7, a method 800 for receiving multimedia content from a remote server in accordance with an exemplary embodiment of the present invention is illustrated. Method 800 can be performed by receiver 204 and can complement method 700. Method 800 can begin at step 802, in which the receiver 204 can obtain an indication of the parameters of the client display device 106, as discussed above. For example, the indication can be a display device make and model, as discussed above. Further, certain parameters can be obtained using an HDMI connection, as discussed above. In addition, it can employ sensors 130 and 134 to obtain client display device parameters. For example, as discussed above, the ambient environment sensor 130 can be configured to measure ambient light color and intensity. Further, the bandwidth sensor 134 can be configured to measure the bandwidth of a transmission channel 110, 108 connected to the remote server.

At step 804, the receiver 204 can transmit the indication of client display device parameters of the client display device 106 to the remote server, as discussed above. For example, as discussed above, the indication can include the make and model of the display device and can include explicit description of the parameters. As noted above, such parameters can include decoding and scanning parameters, color information, and ambient environment information and bandwidth. Further, as stated above, the color information can include a gamut ID.

Optionally, at step 806, the receiver 204 can transmit a request for multimedia content, as discussed above.

At step 808, the receiver 204 can receive multimedia content and an indication of display device parameter settings for the multimedia content that are optimized for the client display device, as discussed above. For example, as stated above, such parameters can include color settings, brightness, volume, and other parameters. The color settings can include 1D or 3D LUTs, as noted above.

The receiver 204 can set the client display device and/or modify the multimedia content in accordance with the received set of parameter settings.

For example, at step 810, the parameter controller 226 of receiver 204 can set the client display device in accordance with the set of display device parameter settings for the display of the multimedia content, as discussed above. For example, the parameter controller 226 can adjust the color settings, brightness, volume and other parameters using the set of settings obtained from the server 201. Further, as noted above, the parameter controller 226 can indicate to the user how the ambient lighting should be adjusted in accordance with the settings or can automatically modify the ambient light.

At step 812, the parameter controller 226 can modify the multimedia content in accordance with the set of display device parameter settings. For example, the parameter controller 226 can perform color transformations on the multimedia content in accordance with the set of parameter settings so that the content matches, as much as possible, a predetermined optimal settings model provided in the ideal pictures database 118.

At step 814, the display device 106 can display the multimedia content in accordance with the set of display device parameter settings. As such, an optimized picture can be automatically presented to the user.

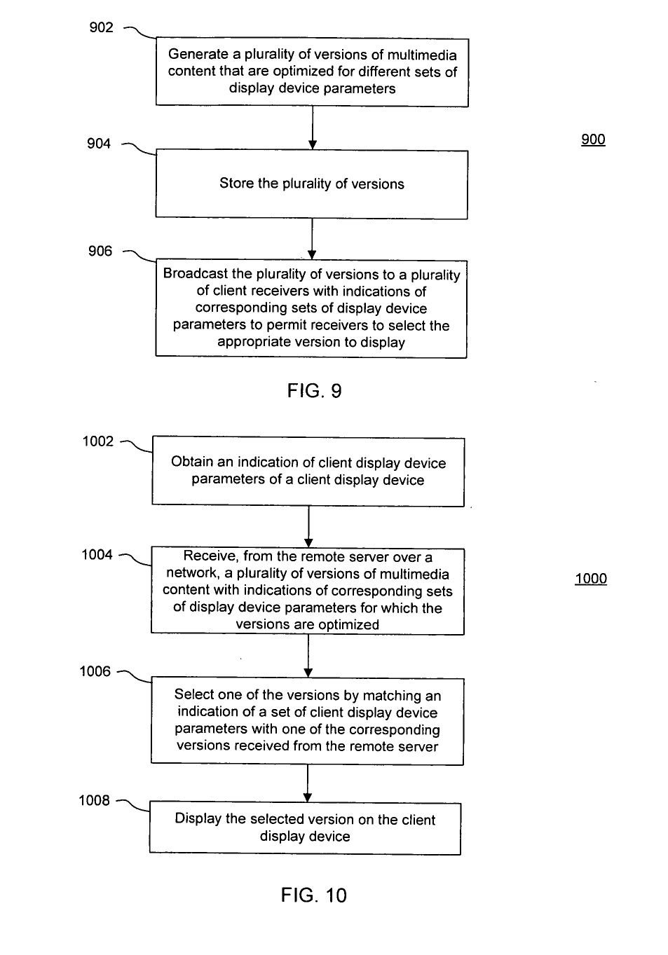

Referring now to FIG. 9 with continuing reference to FIG. 3, a method 900 for delivering content in accordance with one exemplary embodiment of the present invention is illustrated. For example, method 900 can be performed by remote server 301 of system 300. Method 900 can begin, for example, at step 902 in which the content generator 114 can generate a plurality of versions of multimedia content that are optimized for different sets of display device parameters, as discussed above. Further, the versions of multimedia content can be generated so that they parallel the parameters in the ideal picture database 118 for the content as much as possible, as discussed above. Alternatively, the plurality of versions need not be generated at the server but can be received from a remote content generator and stored directly in the content storage device 116.

At step 904, the server 301 can store the plurality versions in the content storage device 116.

At step 906, the remote server 301 can be configured to broadcast to a plurality of receivers the plurality of versions to a plurality of client receivers with indications of corresponding sets of display device parameters to permit receivers to select the appropriate version to display. For example, as noted above, the indications of the sets of video display parameters can be makes and models of the display device 106 or they can be detailed descriptions of corresponding client device parameters, as discussed above. Further, the indications can be transmitted in the form of a reference table 313 that relates the different versions of content to their corresponding display device make and models.

Referring to FIG. 10, with continuing reference to FIGS. 3 and 9, a method 1000 for receiving multimedia content from a remote server in accordance with an exemplary embodiment of the present invention is illustrated. Method 1000 can be performed by receiver 304 and can complement method 900. Method 1000 can begin at step 1002, in which the receiver 304 can obtain an indication of the parameters of the client display device 106, as discussed above. For example, the indication can be a display device make and model, as discussed above.

At step 1004, the receiver 304 can receive, from the remote server over a network, a plurality of versions of multimedia content with indications of corresponding sets of display device parameters for which the versions are optimized. As noted above, the indications can be, for example, device make and model numbers transmitted in the form of a reference table 313 relating the indications to their corresponding versions.

At step 1006, the version selector 326 of receiver 304 can select one of the versions by matching an indication of a set of client display device parameters with one of the corresponding versions received from the remote server. For example, the version selector 326 can match a make and model obtained at step 1002 with a corresponding version using the reference table 313.

At step 1008, the display device 106 can display the selected version, which is optimized for the display device.

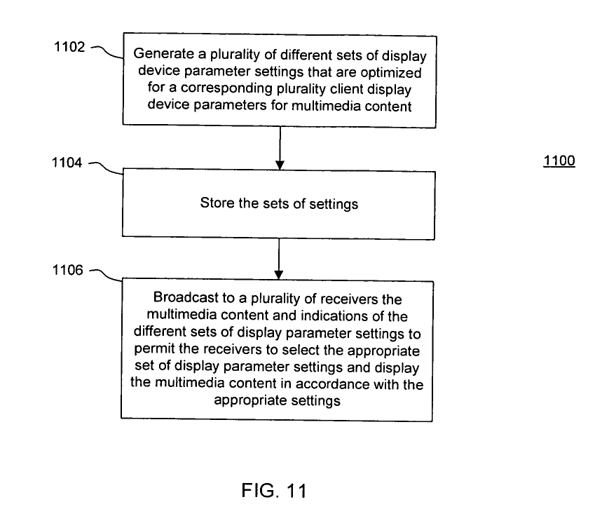

With reference now to FIG. 11 with continuing reference to FIG. 4, a method 1100 for delivering content in accordance with one exemplary embodiment of the present invention is illustrated. For example, method 1100 can be performed by remote server 401 of system 400. Method 1100 can begin, for example, at step 1102 in which the settings generator 214 can generate a plurality of different sets of display device parameter settings that are optimized for a corresponding plurality client display device parameters for multimedia content, as discussed above. Further, the sets of parameter settings can be generated so that they parallel the parameters in the ideal picture database 118 for the content as much as possible, as discussed above. Alternatively, the plurality of versions need not be generated at the server but can be received from a remote settings generator and stored directly in the settings storage device 216.

At step 1104, the server 201 can store the generated sets of parameters settings in the settings storage device 216.

At step 1106, the remote server 401 can be configured to broadcast to a plurality of receivers the multimedia content and indications of the different sets of video display parameter settings to permit the receivers to select the appropriate set of video display parameter settings and display the multimedia content in accordance with the appropriate settings. For example, as noted above, the indications of the sets of video display parameters can be transmitted as makes and models of the display device 106 or they can be detailed descriptions of corresponding client device parameters, as discussed above. Further, the indications can be transmitted in the form of a reference table 413 that relates each set of parameters with a corresponding device make and model that can be employed by the receiver 404 to determine the set of parameters that are optimized for display device 106.

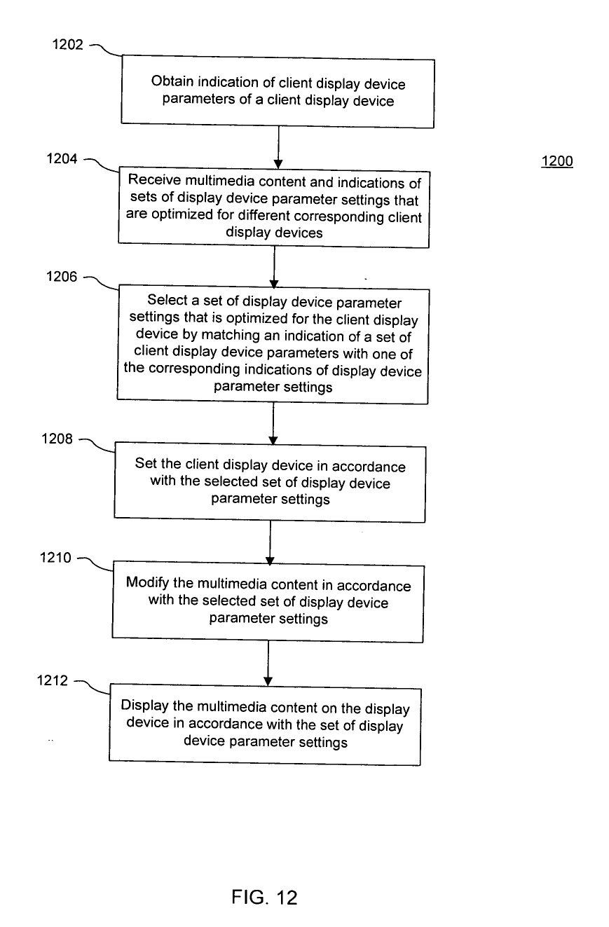

Referring to FIG. 12, with continuing reference to FIGS. 4 and 11, a method 1200 for receiving multimedia content from a remote server in accordance with an exemplary embodiment of the present invention is illustrated. Method 1200 can be performed by receiver 404 and can complement method 1100. Method 1200 can begin at step 1202, in which the receiver 404 can obtain an indication of the parameters of the client display device 106, as discussed above. For example, the indication can be a display device make and model, as discussed above. Further, certain parameters can be obtained using an HDMI connection, as discussed above.

At step 1204, the receiver 404 can receive multimedia content and indications of a plurality of sets of display device parameter settings for the multimedia content that are optimized for different corresponding client display devices, as discussed above.

At step 1206, settings selector 428 can select a set of display device parameter settings that is optimized for a client display device by matching an indication of a set of client display device parameters with one of the corresponding indications of display device parameter settings. For example, as noted above, the indication of a set of client display device parameters can correspond to the make and model obtained at step 1202. In addition, the settings selector 428 can employ reference table 414 to match the make and model of display device 106 with the appropriate set of settings broadcasted from the remote server 401.

Moreover, the receiver 404 can set the client display device and/or modify the multimedia content in accordance with the received set of parameter settings, as discussed above.

For example, at step 1208, the parameter controller 226 of receiver 404 can set the client display device in accordance with the selected set of display device parameter settings for the display of the multimedia content, as discussed above.

At step 1210, the parameter controller 226 can modify the multimedia content in accordance with the selected set of display device parameter settings, as discussed above.

At step 1212, the display device 106 can display the multimedia content in accordance with the selected set of display device parameter settings.

It should also be understood that the method embodiments discussed above focus on specific, features to simplify and ease understanding of the features. However, any of the aspects and/or steps discussed above with regard to one method embodiment can be combined with or added to any one or more of the other method embodiments described. Thus, although certain aspects are described with respect to one embodiment, those aspects can be implemented in any of the other embodiments described.

For example, in accordance with exemplary embodiments of the present invention, methods 500/600 can be combined with methods 700/800. For example, the receiver can first send its capability details in the form of display device parameters to the server over a wide area network. The server can transmit the configuration settings or parameter settings to the receiver for its use. In addition, the server can send the most appropriately optimized multimedia content to the receiver in a unicast mode. For example, the receiver can employ the configuration or parameter settings to perform color management while the content can be RD or SD, MPEG2 or MPEG4, AAC or AC3, 2D vs 3D, etc. This scenario can be implemented in standard broadband networks that are connected to the Internet.

Further, in accordance with exemplary embodiments of the present invention, methods 900/1000 can be combined with methods 1100/1200. For example, the server can broadcast a plurality of configuration settings or parameter settings to be used by the receiver for processing the multimedia content locally. In addition, a plurality of multimedia content versions, which are several instances of the same content but with different formatting—e.g. encoding parameters, color mapping, etc.—can be transmitted to the receiver. Here, the receiver can select the most appropriate configuration setting or parameter settings and the most appropriate multimedia content version in accordance with its local capacities, as discussed above. This scenario can be implemented in standard broadcast networks, such as a satellite network.

Having described various exemplary content delivery embodiments of the present invention, which automatically optimize media content or a display of the media content in accordance with an optimal or ideal picture (and which are intended to be illustrative and not limiting), it is noted that modifications and variations can be made by persons skilled in the art in light of the above teachings. It is therefore to be understood that changes can be made in the particular embodiments of the invention disclosed which are within the scope of the invention as outlined by the appended claims. While the forgoing is directed to various embodiments of the present invention, other and further embodiments of the invention can be devised without departing from the basic scope thereof.

1. A method comprising the steps of:
receiving an indication of at least one client display device parameter over a wide area network from a receiver;
determining a version of multimedia content that is optimized for the client display device based on the client display device parameter such that the display of said version on the display device parallels the display properties of a predetermined optimal model for the content; and
transmitting the version to the receiver.

2. The method of claim 1 further comprising the step of:
performing said determining and transmitting in response to receiving a request for the multimedia content.

3. The method of claim 1 further comprising the step of:
generating said version in response to receiving said indication.

4. The method of claim 1 further comprising the step of:
storing a plurality of versions of the multimedia content that are optimized for different sets of display device parameters, wherein said determining further comprises selecting a proper version to transmit to the receiver by matching the indication of client display device parameters with a corresponding version that is optimized for the client display device parameters.

5. The method of claim 1 further comprising the step of:
including an indication of ambient light surrounding the client display device for said client display device parameters.

6. The method of claim 1 further comprising the step of:
including a gamut identification for said client display device parameters.

7. The method of claim 1 further comprising the step of:
including a brand and model indication for the client display device for said display device parameters.

8. The method of claim 1 further comprising the step of:
generating said version by employing a database indicating parameters of a plurality of different display devices.

9. The method of claim 1 further comprising the step of:
determining parameter display settings for the multimedia content that are optimized for the display device, wherein the transmitting further comprises transmitting an indication of the determined parameter display settings to the receiver over the network.

10. A method for delivering content from a remote server comprising the steps of:
receiving an indication of client display device parameters over a wide area network from a receiver;
determining parameter display settings for the multimedia content that are optimized for the display device; and
transmitting to the receiver the multimedia content and an indication of the determined parameter display settings.

11. The method of claim 10 further comprising the step of:
storing a plurality of different sets of display device parameter settings that are optimized for a corresponding plurality client display device parameters for the multimedia content, wherein said determining comprises selecting one of said different sets of display device parameter settings.

12. The method of claim 10 further comprising the step of:
generating the parameter display settings in response to receiving the indication of client display device parameters.

13. The method of claim 10 further comprising the step of:
generating the parameter display settings such that the parameter display settings parallel a predetermined optimal parameters model.

14. A method comprising:
obtaining an indication of display parameters of a client display device;
transmitting the indication over a wide area network to the remote server; and
receiving a version of multimedia content that is optimized for the display parameters of the client display device.

15. The method of claim 14 further comprising the step of:
receiving, from the remote server over the wide area network, an indication of parameter display settings for the multimedia content that are optimized for the display device.

16. The method of claim 15 further comprising the step of:
setting the display device in accordance with the parameter display settings.

17. The method of claim 16 further comprising the step of:
setting at least one of color, volume, brightness and contrast.

18. The method of claim 15 further comprising the step of:
modifying the version in accordance with the parameter display settings.

19. The method of claim 18 further comprising the step of:
performing color transformations.

20. The method of claim 10 further comprising the steps of:
including a color lookup table for said parameter display settings; and
basing said transformations on the lookup table such that display of said version on the client display device parallels a predetermined optimal parameter model.
